(19) United States
(12) Patent Application Publication
(10) Pub. No.: US 2025/0297709 A1
(43) Pub. Date: Sep. 25, 2025

(54) TANK ARRANGEMENT CONSTRUCTION

(71) Applicant: HONDA MOTOR CO., LTD., Tokyo (JP)

(72) Inventor: Takashi KUWAYAMA, Wako-shi (JP)

(21) Appl. No.: 19/058,402

(22) Filed: Feb. 20, 2025

(30) Foreign Application Priority Data
Mar. 25, 2024 (JP) 2024-048739

(51) Int. Cl. F17C 13/04

(52) U.S. Cl. CPC F17C 13/04; F17C 2201/0109; F17C 2205/0146; F17C 2205/0192; F17C 2221/012; F17C 2270/0168

(57) ABSTRACT

A tank arrangement construction includes two or more first tanks and one or more second tanks are arranged such that tank axes thereof are parallel to each other with the connections are aligned on the same side. The first tanks are arranged in a first direction intersecting with directions of the tank axes. The second tank is offset from the first tanks arranged in the first direction, in a second direction intersecting the directions of the tank axes and the first direction. A diameter D1 of each first tank and a diameter D2 of each second tank are different from each other. The first tanks and the second tanks are arranged in a zigzag pattern. The first tanks and the second tanks lap each other as viewed in the first direction.

### BACKGROUND

The present application claims priority under 35 U.S.C. § 119 to Japanese Patent Application No. 2024-048739, filed on Mar. 25, 2024, the contents of which are hereby incorporated by reference in their entirety.

The present disclosure relates to a construction in which tanks capable of storing a fluid are arranged.

In recent years, research and development have been conducted on electric vehicles that contribute to energy efficiency, so that more people can secure access to energy that is convenient, reliable, sustainable, and advanced. Japanese Patent Application Laid-Open No. Hei7-149156A describes a construction which includes tanks of the same shape for storing pressurized fluid arranged in multiple stages (three stages).

### SUMMARY

Such a construction, however, requires a large space in the direction of the stage in which the tanks are stacked, and the gaps between the tanks are large, so that the storage efficiency of the fluid is not good.

The present disclosure is directed to a tank arrangement construction that achieves both space saving and improvement in fluid storage efficiency, and thus contributes to energy efficiency.

A tank arrangement construction according to an embodiment of the present disclosure includes: three or more tanks having connections at one ends respectively and capable of storing a fluid; and a manifold connected to the connections of the three or more tanks so as to allow for fluid communication with the connections. The three or more tanks are arranged such that tank axes thereof are parallel to each other with the connections aligned on the same side. The three or more tanks include two or more first tanks arranged in a first direction intersecting directions of the tank axes. The three or more tanks include one or more second tanks offset from the two or more first tanks arranged in the first direction, in a second direction intersecting the directions of the tank axes and the first direction. A diameter of each first tank is different from a diameter of the second tank. The two or more first tanks and the one or more second tanks are arranged in a zigzag pattern. The first tanks and the second tanks lap each other as viewed in the first direction.

According to the present disclosure, the two-stage tank arrangement construction achieves both space saving and improvement in fluid storage efficiency, and further contributes to energy efficiency.

### BRIEF DESCRIPTION OF THE ACCOMPANYING DRAWINGS

FIG. 1 is a schematic view (plan view) of a tank arrangement construction according to a basic embodiment of the present disclosure as viewed in the second direction.

FIG. 2 is a schematic view (side view) of the tank arrangement construction according to the basic embodiment of the present disclosure as viewed in the first direction.

FIG. 3 shows a schematic view (front view) of a first tank and a second tank of the tank arrangement construction according to a basic embodiment of the present disclosure as viewed in the tank axial direction.

FIG. 4 is a schematic view (front view) of the first tank, the second tank, and the manifold of the tank arrangement construction according to the first embodiment of the present disclosure as viewed in the tank axial direction.

FIG. 5 is a schematic view (front view) of a first tank, a second tank, and a manifold of a tank arrangement construction according to a second embodiment of the present disclosure, as viewed in the tank axial direction.

FIG. 6 is a schematic view (front view) of a first tank, a second tank, and a manifold of a tank arrangement construction according to a third embodiment of the present disclosure, as viewed in the tank axial direction.

FIG. 7 is a schematic view (front view) of a first tank, a second tank, and a manifold of a tank arrangement construction according to a fourth embodiment of the present disclosure, as viewed in the tank axial direction.

### DESCRIPTION OF THE EMBODIMENTS

Next, an embodiment of the present disclosure will be described in detail with reference to the drawings as appropriate, taking, as an example, a case where a tank arrangement construction of the present disclosure is applied to arrangement of a hydrogen tank of an electric vehicle as an electricity-driven vehicle. In the following description, expressions indicating directions such as front and rear, left and right, and up and down are based on an electric vehicle as a vehicle. In the following embodiments, the tank axial direction (direction of tank axes) coincides with the front-rear direction, the first direction coincides with the left-right (vehicle width) direction, and the second direction coincides with the up-down direction. Meanwhile, respective directions of the tank arrangement construction do not have to coincide with the front-rear direction, the left-right direction, and the up-down direction of the vehicle.

### Basic Embodiment

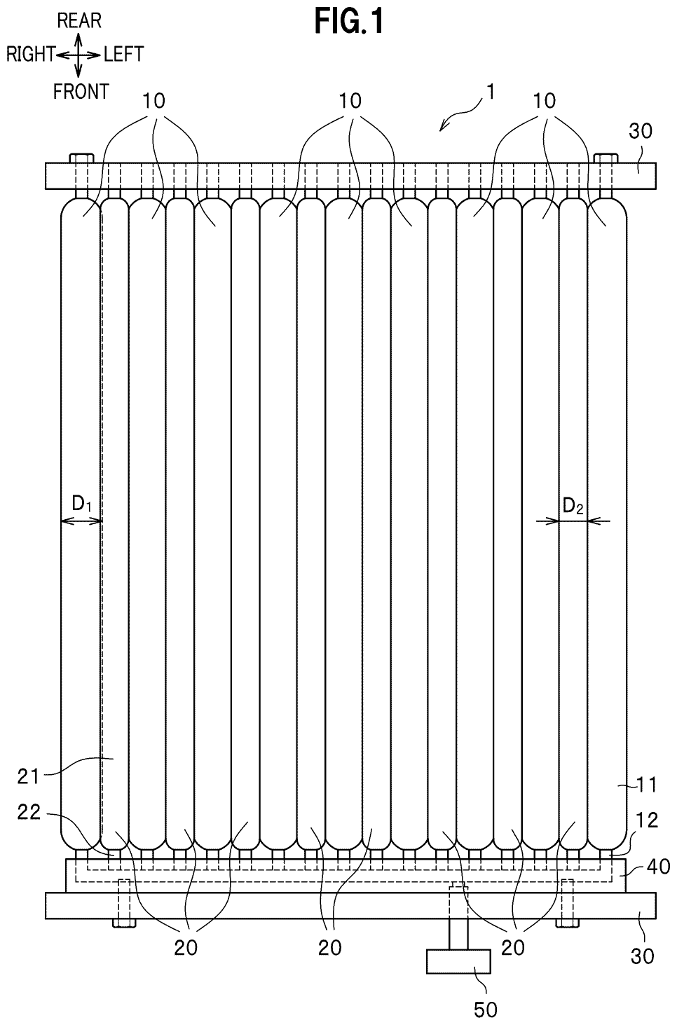

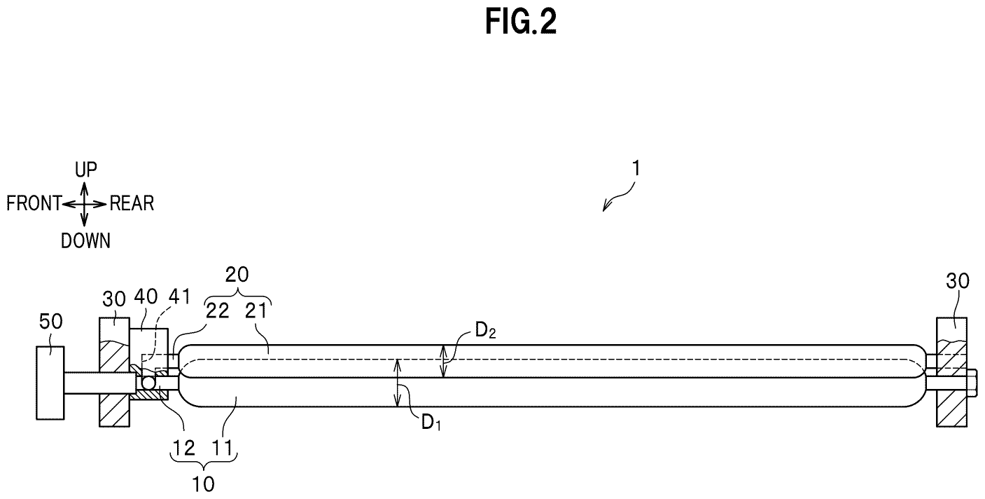

As shown in FIGS. 1 and 2, a tank arrangement construction 1 according to a basic embodiment of the present disclosure includes two or more first tanks 10, one or more (two or more in the present embodiment) second tanks 20, a pair of brackets 30,30, a manifold 40, and a valve 50.

### First Tank

The first tanks 10 each include a tank body 11 capable of storing a fluid (for example, compressed high-pressure hydrogen). Each first tank 10 is provided at one end of the tank main body 11 in the directions of tank axes (tank axial direction), and includes a connection 12 through which a fluid can flow. The tank body portion 11 and the connection 12 may be integrally formed in advance or may be separate members. The materials of the tank body 11 and the connection 12 are not particularly limited as long as the materials can bear the pressure of the stored fluid. The tank body 11 has a substantially elongated cylindrical shape with a diameter D1. The first tanks 10 are arranged in a row in a first direction (in the present embodiment, a left-right (vehicle width) direction) in a posture in which the axial directions of the first tanks are along the front-rear direction of the vehicle and the connections 12 are on the front side. The first tanks 10 constitute a first stage on the lower side of the tank arrangement construction 1.

### Second Tank

The second tanks 20 each include a tank body 21 capable of storing a fluid. Each second tank 20 includes a connection 22 which is provided at one end in the axial direction of the tank body 21 and through which a fluid can flow. The tank body 21 and the connection 22 may be integrally formed in advance or may be separate members. The materials of the tank body 21 and the connection 22 are not particularly limited as long as the materials can bear the pressure of the stored fluid. The tank body 21 has a substantially elongated cylindrical shape with a diameter D2. The second tanks 20 are arranged in a row in the first direction (in the present embodiment, the left-right (vehicle width) direction) in a posture in which the axial directions of the second tanks are along the front-rear direction of the vehicle and the connections 22 are on the front side. The second tanks 20 constitute the second stage on the upper side of the tank arrangement construction 1.

### Relationship between Diameters of First Tank and Second Tank

The diameter D₁ of each first tank 10 and the diameter D₂ of each second tank 20 are different (D₁≠D₂). The diameter D₁ of each first tank 10 is larger than the diameter D₂ of each second tank 20 (D1>D2).

### Bracket

One bracket 30 holds one ends of two or more first tanks 10 and one or more second tanks 20 in the tank axial direction (in the present embodiment, the front ends closer to the connections 12, 22) and fixes the tanks to vehicle body. The other bracket 30 holds the other ends of the two or more first tanks 10 and the one or more second tanks 20 in the tank axial direction (rear ends in the present embodiment) and fixes the tanks to the vehicle body. The brackets 30 each have a shape, in which it extends in the first direction. The brackets 30 are fixed to the vehicle body by bolt fastening or the like at the opposite ends of the bracket 30 in the first direction. The materials of the brackets 30 are not particularly limited as long as the materials can bear the load of the first tank 10 and the second tank 20 in which the fluid is stored.

### Manifold

The manifold 40 has a shape, in which it extends in the first direction. The manifold 40 is connected in fluid communication with the connections 12 of two or more first tanks 10 and the connections 22 of one or more second tanks 20. The manifold 40 includes a flow path 41 therein through which a fluid can flow between the connections 12, 22 and the outside of the manifold 40. The material of the manifold 40 is not particularly limited as long as the material can bear the pressure of the fluid flowing through the flow path 41.

### Valve

The valve 50 is attached to the external end of the flow path 41 of the manifold 40 (an opening defined on the surface of the manifold 40). The valve 50 is allowed to switch between a valve open state in which the flow of the fluid is allowed and a valve closed state in which the flow of the fluid is shut off.

### Arrangement of First Tank and Second Tank

The two or more first tanks 10 and the one or more second tanks 20 are arranged such that the tank axes thereof are parallel to each other (in the embodiment, parallel to each other) with the connections 12,22 aligned on the same side (closer to the manifold 40, in the embodiment, the front side). The two or more first tanks 10 are arranged in a first direction (in the present embodiment, the left-right direction) that intersects (in the present embodiment, is orthogonal to) the tank axial direction of the first tanks 10. The one or more second tanks 20 are offset from the row of the first tanks 10 in a second direction (in the present embodiment, the upward direction) intersecting (in the present embodiment, orthogonal to) the tank axial direction and the first direction of the first tanks 10 and the first direction. In the present embodiment, the two or more second tanks 20 are arranged in a first direction (in the present embodiment, the left-right direction) that intersects (in the present embodiment, is orthogonal to) the directions of the tank axes (tank axial direction) of the second tanks 20. The first tanks 10 and the second tanks 20 are arranged in a zigzag pattern in which the first tanks 10 and the second tanks 20 alternately arranged in the first direction as viewed in the tank axial direction. That is, when N is a natural number of 1 or more, the tank arrangement construction 1 includes N+1 of the first tanks 10 and N, N+1, or N+2 of the second tanks 20. In the portions other than both the opposite ends in the first direction, the first tanks 1 are disposed between two neighboring second tanks 20,20 so as to be offset from the second tanks 20 in the second direction (downward in the present embodiment). The second tanks 20 are disposed between two neighboring first tanks 10,10 so as to be offset from the first tanks 10 in the second direction (upward in the present embodiment).

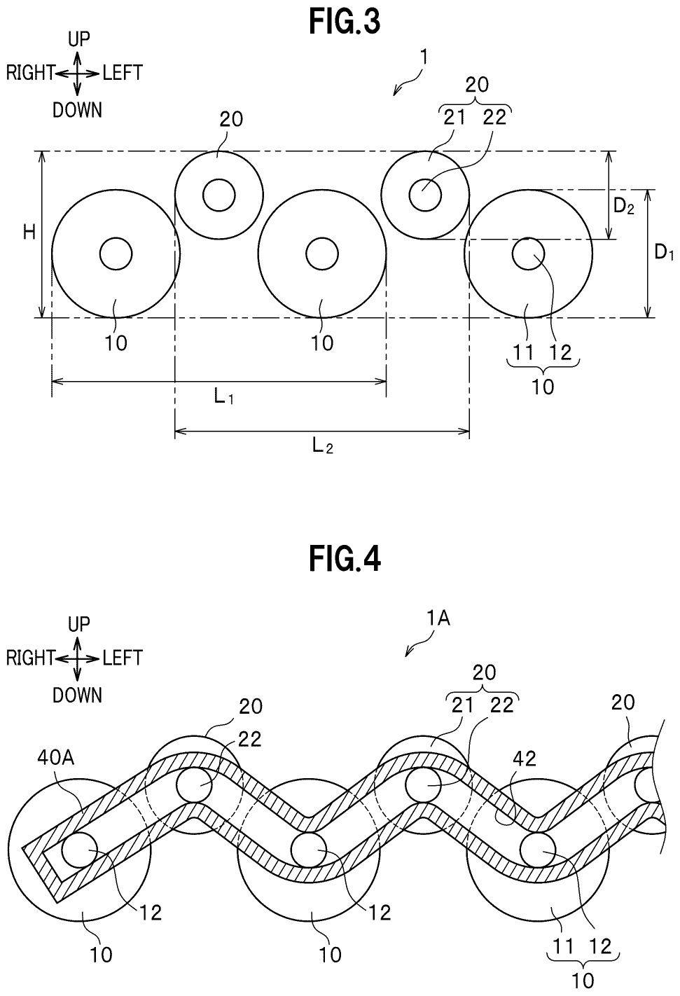

The first tanks 10 and the second tanks 20 lap each other in the second direction as viewed in the first direction. In other words, the lower ends of the second tanks 20 are respectively positioned below the upper ends of the first tanks 10. That is, the second directional dimension H of the tank arrangement construction 1 satisfies the following relationship (see FIG. 3).

H<D₁+D₂

The first tanks 10 and the second tanks 20 lap each other in the first direction as viewed in the second direction. In other words, the left ends of the second tanks 20 are respectively positioned further to the left of the right ends of the first tanks 10 which are diagonally down to the left. The right ends of the second tanks 20 are respectively positioned to the right of the left ends of the first tanks 10 which are diagonally down to the right. Similarly, the left ends of the first tanks 10 are respectively positioned further to the left of the right ends of the second tanks 20 which are diagonally up to the left. The right end of the first tank 10 is positioned to the right of the left end of the second tank 20, which is diagonally up to the right. That is, the first directional size L₁ of two neighboring first tanks 10 and one second tank 20 therebetween in the tank arrangement construction 1 satisfies the following relationship (see FIG. 3).

L₁<2D₁+D₂

A first direction size L₂ of two neighboring second tanks 20 and one first tank 10 therebetween in the tank arrangement construction 1 satisfies the following relationship (see FIG. 3).

L₂<D₁+2D₂

Here, the neighboring first tanks 10, the neighboring second tanks 20, and the neighboring first tank 10 and second tank 20 are respectively spaced apart from each other. In the tank arrangement construction 1, the diameter D₁ of each first tank 10 and the diameter D2 of each second tank 20 are different (D₁>D₂). Therefore, as compared with the case where the diameter of each first tank 10 and the diameter of each second tank 20 are the same, the space between the first tank 10 and the second tank 20 is reduced, thereby achieving space saving in the first direction and the second direction and improvement in the storage efficiency of the fluid.

A tank arrangement construction 1 according to the basic embodiment of the present disclosure includes three or more tanks 10, 20 each having a connection 12, 22 at one end and capable of storing a fluid, and a manifold 40 connected to the connections 12, 22 of the three or more tanks 10, 20 so as to allow the fluid to flow therethrough. The three or more tanks 10, 20 are arranged such that the tank axes are parallel to each other with the connections 12, 22 are aligned on the same side. The two or more tanks are two or more first tanks 10 arranged in the first direction intersecting the tank axial directions of the tank axes. The one or more tanks are one or more second tanks 20 offset from the two or more tanks 10 arranged in the first direction, in the second direction intersecting the directions of tank axes and the first direction. Each first tank 10 has a diameter D1 different from a diameter D2 of each second tank 20. The two or more first tanks 10 and the one or more second tanks 20 are arranged in a zigzag pattern. The first tanks 10 and the second tanks 20 lap each other as viewed in the first direction.

Therefore, the tank arrangement construction 1 achieves both space saving in the second direction and improvement in the storage efficiency of the fluid. The tank arrangement construction 1 reduces in size of the manifold 40 in the second direction.

In the tank arrangement construction 1, the first tanks 10 and the second tanks 20 neighboring to each other lap each other as viewed in the second direction.

Therefore, the tank arrangement construction 1 achieves both space saving in the first direction and the second direction and improvement in the storage efficiency of the fluid. The tank arrangement construction 1 reduces in size of the manifold 40 in the first direction.

### First Embodiment

Next, the manifold 40A of the tank arrangement construction 1A according to the first embodiment of the present disclosure will be described with reference to FIG. 4. FIG. 4 shows a cross-sectional configuration of the manifold 40A having a flow path 42 therethrough.

As shown in FIG. 4, the manifold 40A of the tank arrangement construction 40A has a bent shape, in which the manifold 40A is alternately connected to the connections 12 of the first tanks 10 and the connections 22 of the second tanks 20 as viewed in the tank axial direction. The flow path 42 allows a fluid to flow therethrough. The manifold 40A includes a flow path 42 having a bent shape (polygonal line shape) in which ridges and troughs are alternately arranged by alternately connecting the connections 12, 22 as viewed in the tank axial direction.

The manifold 40A has a bent shape in which the manifold 40A are alternately connected to the connections 12 of the first tanks 10 and the connections 22 of the second tanks 20 as viewed in the tank axial direction.

Therefore, the tank arrangement construction 1A reduces in size of the manifold 40A.

### Second Embodiment

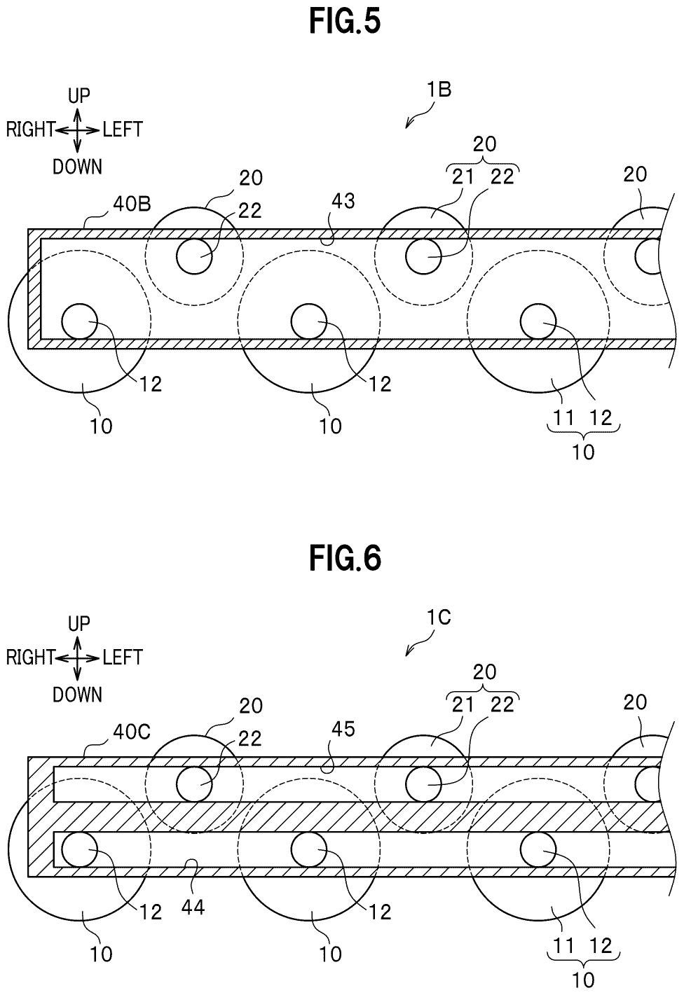

Next, a manifold 40B of a tank arrangement construction 1B according to a second embodiment of the present disclosure will be described with reference to FIG. 5. FIG. 5 shows a cross-sectional configuration of the manifold 40B having a flow path 43 therethrough.

As shown in FIG. 5, the manifold 1B of the tank arrangement construction 40B has a shape, in which it extends in the first direction with a width so as to cover the connections 12 of the first tanks 10 and the connections 22 of the second tanks 20, as viewed in the tank axial direction. The manifold 40B includes a flow path 43 which allows a fluid to flow therethrough. The flow path 43 has a shape, in which the flow path 43 extends in the first direction and covers the connections 12 of the first tanks 10 and the connections 22 of the second tanks 20 as viewed in the tank axial direction.

The manifold 40B has a shape, in which it extends in the first direction with a width so as to cover the connections 12 of the first tanks 10 and the connections 22 of the second tanks 20, as viewed in the tank axial direction.

Accordingly, the tank arrangement construction 1B improves in the manufacturability of the manifold 40B.

### Third Embodiment

Next, a manifold 40C of a tank arrangement construction 1C according to a third embodiment of the present disclosure will be described with reference to FIG. 6, following on differences from the manifold 40B of the second embodiment. FIG. 6 shows the cross-sectional shape of the manifold 40C at the position where the first flow path 44 and the second flow path 45 are present.

As shown in FIG. 6, the manifold 40C extends in the first direction as a flow path through which a fluid can flow, instead of the flow path 43. The manifold 40C includes a first flow path 44 communicating with the connections 12 of the two or more first tanks 10 and a second flow path 45 extending in the first direction and communicating with the connections 22 of the one or more second tanks 20.

In the present embodiment, the first flow path 44 is connected to an opening defined on the surface of the manifold 40C. In the opening, a valve 50 (see FIGS. 1 and 2) is disposed. The second flow path 45 is connected to an opening defined on the surface of the manifold 40C. In the opening, another valve 50 (see FIGS. 1 and 2) is disposed. The two valves 50, 50 may be connected to each other by a flow path outside the manifold 40C.

The manifold 40C includes, as a flow path through which the fluid can flow, a first flow path 44 communicating with the connections 12 of the two or more first tanks 10 and a second flow path 45 communicating with the connections 22 of the one or more second tanks 20.

Thus, the tank arrangement construction 1C improves in the manufacturability of the manifold 40C. The tank arrangement 1C allows the fluid of each stage to be stored and discharged independently, provided that each of the first flow path 44 and second flow path 45 communicates with the outside of the manifold 40C.

### Fourth Embodiment

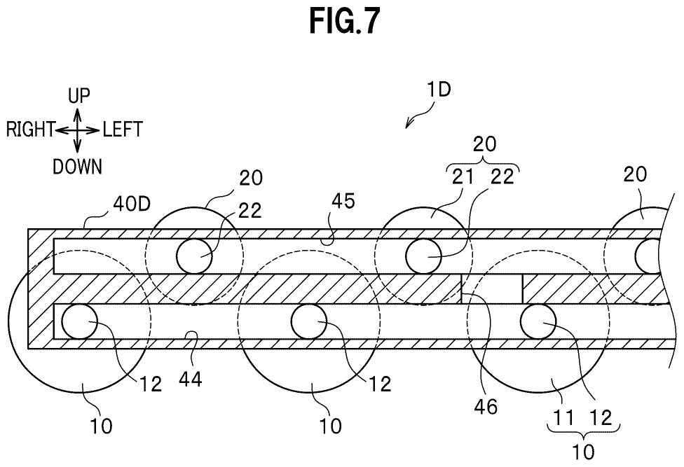

Next, a manifold 40D of a tank arrangement construction 1D according to a fourth embodiment of the present disclosure will be described with reference to FIG. 7, following on differences from the manifold 40C of the third embodiment. FIG. 7 shows a cross-sectional configuration of the manifold 40D having a first flow path 44, a second flow path 45, and a third flow path 46 therein.

As shown in FIG. 7, the manifold 40D includes, as a flow path through which a fluid can flow, a third flow path 46 which connects the first flow path 44 and the second flow path 45, in addition to the first flow path 44 and the second flow path 45.

The third flow path 46 is connected to an opening defined in the 40D of the manifold. In the opening, a valve 50 (see FIGS. 1 and 2) is disposed.

The manifold 40D includes, as a flow path through which the fluid can flow, a third flow path 46 which connects the first flow path 44 and the second flow path 45.

Thus, the tank arrangement construction 1D improves in the manufacturability of the manifold 40D and allows the fluids in respective rows to be stored and discharged together.

Although the embodiments of the present disclosure have been described above, the present disclosure is not limited to the embodiments, and can be appropriately modified without departing from the gist of the present disclosure. For example, the bracket 30 may have a shape that follows the manifolds 40A, 40B. The diameter D₂ of the second tank 20 may be larger than the diameter D₁ of the first tank 10.

What is claimed is:

1. A tank arrangement construction comprising:
three or more tanks having connections at one ends respectively and capable of storing a fluid; and
a manifold connected to the connections of the three or more tanks so as to allow for fluid communication with the connections,
wherein the three or more tanks are arranged such that tank axes thereof are parallel to each other with the connections aligned on the same side,
wherein the three or more tanks include two or more first tanks arranged in a first direction intersecting directions of the tank axes,
wherein the three or more tanks include one or more second tanks offset from the two or more first tanks arranged in the first direction, in a second direction intersecting the directions of the tank axes and the first direction,
wherein a diameter of each first tank is different from a diameter of each second tank, wherein the two or more first tanks and the one or more second tanks are arranged in a zigzag pattern, and
wherein the first tanks and the second tanks lap each other as viewed in the first direction.

2. The tank arrangement construction according to claim 1,
wherein a first tank and a second tank neighboring to each other lap each other as viewed in the second direction.

3. The tank arrangement construction according to claim 1,
wherein the manifold has a bent shape in which the manifold is alternately connected to connections of the first tanks and connections of the second tanks as viewed in the directions of the tank axes.

4. The tank arrangement according to claim 1,
wherein the manifold has a shape in which the manifold extends in the first direction with a width so as to cover the connections of the first tanks and the connections of the second tanks as viewed in the directions of the tank axes.

5. The tank arrangement construction according to claim 4,
wherein the manifold includes, as a flow path through which the fluid can flow, a first flow path communicating with the connections of the two or more first tanks; and
a second flow path communicating with the connections of the one or more second tanks.

6. The tank arrangement construction according to claim 5,
wherein the manifold includes, as a flow path through which the fluid can flow, a third flow path connecting the first flow path and the second flow path.
